(19) United States
(12) Patent Application Publication
(10) Pub. No.: US 2016/0124485 A1
(43) Pub. Date: May 5, 2016

(54) COMPUTER SYSTEM HAVING AN ABSENCE MODE

(71) Applicant: FUJITSU TECHNOLOGY SOLUTIONS INTELLECTUAL PROPERTY GMBH, München (DE)

(72) Inventors: Waldemar FELDE, Augsburg (DE); Jürgen HIMML, Graben (DE); Peter PFEIFFER, Augsburg (DE)

(73) Assignee: Fujitsu Technology Solutions Intellectual Property GmbHü, München (DE)

(21) Appl. No.: 14/443,551

(22) PCT Filed: May 27, 2014
(86) PCT No.: PCT/EP2014/060912

§ 371 Date: May 18, 2015

(30) Foreign Application Priority Data
Jun. 26, 2013 (DE) 102013106699.2

(51) Int. Cl. G06F 1/32; G06F 9/44; H04W 80/12

(52) U.S. Cl. CPC G06F 1/3231; H04W 80/12; G06F 1/3287; G06F 1/329; G06F 9/4418

(57) ABSTRACT

A computer system includes a system component, at least one non-volatile mass memory, and at least one power supply unit that supplies power. The computer system has at least one system software component having an interface that selects energy-saving functions, which interface provides at least one function that operates the computer system in an absence mode in which at least one first application running on the computer system can be addressed via a network connection. At least one software component is executed by an operating system during operation of the computer system, which software component stops at least one second application when absence of a user is detected and calls the function that operates the computer system in the absence mode via the interface.

### TECHNICAL FIELD

This disclosure relates to a computer system comprising a system component having a non-volatile memory module that stores a system software component to control hardware components of the system component, at least one non-volatile mass memory that stores an operating system and associated software components, and at least one power supply unit that supplies the system component and the mass memory with a supply voltage. The disclosure relates, in particular, to improved energy management for such a computer system.

### BACKGROUND

Computer systems of the type mentioned at the outset are widely known. In particular, so-called “desktop” computers generally have a system component in the form of a system board with hardware components arranged on the latter, for example, a processor, a chipset and a non-volatile memory module that stores BIOS code to start the computer system. Further internal components, for example, non-volatile mass memory drives such as magnetic hard disks or semiconductor memory drives, are often connected to the system component and usually store an operating system, for example, Windows 8 with associated driver components. During operation of the computer system, the processor executes program code of the operating system, of associated software components or of the system software component and applications called by a user.

Such computers are widely used in office environments, in particular, and generally operate more or less without interruption at least during normal working hours, for example, from 8 AM to 5 PM.

Against the background of climate change in general and the effort to improve the energy efficiency of electrical devices in particular, it could be helpful to further improve the energy balance of such computer systems.

A multiplicity of approaches to improving the energy efficiency of computer systems are known.

A widespread energy-saving approach is described by the so-called “ACPI” standard (“Advanced Configuration and Power Interface Specification”), revision 5.0 dated Dec. 6, 2011, from Hewlett Packard Corporation, Intel Corporation, Microsoft Corporation, Phoenix Technologies Limited and Toshiba Corporation. The standard provides, inter alia, different power states G0 to G3 and different operating states or sleep states S0 to S4 within the power state G0. A computer system is respectively completely ready for operation in the numerically lowest states, that is to say the G0 power state and the S0 operating state. The energy consumption of the computer system is reduced in accordingly higher-ranking states, in particular to reduce the power consumption of the computer in one or more sleep states.

One problem of the states known from the ACPI standard is that no user applications are executed in all operating states, apart from the G0/S0 operating state, and virtually no communication can take place between the system and the outside world, apart from receiving particular wake-up events. The known energy-saving states, in particular, are therefore not suitable for computer systems which provide background tasks, for example, continued network communication or reachability via a special application, for example, a Voice-over-IP application (VoIP) or a chat application. They are also not suitable for those computer systems that execute user-specific applications for reminders or other ongoing tasks, for example, the playback of music.

It could further be helpful to provide a universally usable but nevertheless energy-efficient overall concept as well as methods and apparatuses of operating computer systems mentioned at the outset.

### SUMMARY

We provide a computer system including a system component having a non-volatile memory module that stores a system software component of a firmware layer to control hardware components of the system component; at least one non-volatile mass memory that stores an operating system and associated software components; and at least one power supply unit that supplies the system component and the non-volatile mass memory with a supply voltage; the system software component of the firmware layer providing at least one interface that selects energy-saving functions, which interface provides at least one function to operate the computer system in an absence mode in which at least one first application running on the computer system can be addressed via a network connection; at least one software component of an operating system layer being executed by the operating system during operation of the computer system, which software component is configured to stop at least one second application when absence of a user is detected and call the function that operates the computer system in the absence mode via the interface; and the system software component of the firmware layer configured to change at least one hardware component of the computer system into an energy-saving state when the function that operates the computer system in the absence mode is called to reduce energy consumption of the computer system when the user is absent.

We further provide a non-volatile memory device storing at least one software component of an operating system layer of a computer system, which cause a data processing device of the computer system to perform the following steps on execution of the at least one software component: detecting the absence of a user from the computer system; when the absence of a user is detected, stopping at least one application executing under the control of the operating system in an application layer; and when the absence of a user is detected, further calling a function provided by an interface of a system software component of a firmware layer of the computer sytem that operates the computer system in an absence mode, wherein the system software component is configured to change at least one hardware component of the computer system into an energy-saving state when the function that operates the computer system in the absence mode is called to reduce the energy consumption of the computer system.

We yet further provide a non-volatile memory device storing at least one system software component of a firmware layer of a computer system that controls hardware components of a system component of the computer system, which cause a data processing device of the computer system to perform the following steps on execution of the at least one system software component: providing at least one interface that selects energy-saving functions, the interface providing at least one function that operates the computer system in an absence mode, in which at least one first application running under the control of an operating system in an application layer of the computer system can be addressed via a network connection; when the function that operates the computer system in the absence mode is called by software component of an operating system layer of the computer system, changing at least one hardware component of the computer system into an energy-saving state to reduce the energy consumption of the computer system.

### BRIEF DESCRIPTION OF THE DRAWINGS

FIG. 1 shows a system architecture of a computer system according to one example.

FIG. 2 shows a diagram of different software components for implementing an absence mode.

FIG. 3 shows a state diagram for a computer system having an absence mode according to one example.

FIGS. 4A to 4H show flowcharts of a method of implementing an absence mode.

### LIST OF REFERENCE SYMBOLS

1 Computer system

2 System board

3 Power supply unit

4 Mass memory drive

5 Processor

6 Chipset

7 Volatile memory module

8 Microcontroller

9 Mass memory controller

10 Network interface

11 Input/output interface

12 Graphics module

13 BIOS program code

14 Non-volatile memory module

15 Operating system

16 Software component

17 Memory bus

18 Peripheral bus

19 System management bus

20 Software stack

21 Firmware layer

22 BIOS interface

23 ACPI interface

24 Proprietary interface

25 Function

26 Operating system layer

27 Kernel layer

28 User layer

29 Operating system core

30 ACPI driver

31 Driver (for real-time clock)

32 First system service

33 Second system service

34 First setting mask

35 Second setting mask

36 Application layer

37 First application (VoIP application)

38 Second application (Web browser)

39 Third application (electronic appointments calendar)

40 Scheduler

41 Working mode

42 Absence mode

43 Presence sensor

### DETAILED DESCRIPTION

We provide a computer system including a system software component providing at least one interface to select energy-saving functions, which interface provides at least one function that operates the computer system in an absence mode in which at least one first application running on the computer system can be addressed via a network connection. In addition, at least one software component is executed by the operating system during operation of the computer system, which software component is set up to stop at least one second application when absence of a user is detected and to call the function to operate the computer system in the absence mode via the interface. The system software component is set up to change at least one hardware component of the computer system into an energy-saving state when the function to operate the computer system in the absence mode is called to reduce the energy consumption of the computer system when the user is absent.

The above-mentioned measures enable a combined hardware and software solution that controls the computer system. In this case, individual applications can be stopped on the software side to reduce utilization of the processor, while further applications, in particular the first application that provides a network connection can continue to run. At the same time, a system-specific function, which is therefore independent of the operating system, that optimizes the hardware in an absence mode is enabled via the interface of the system software component.

The individual measures which are used on the software side and/or hardware side to achieve the intended energy saving may differ from computer system to computer system and from application scenario to application scenario. They partially form subjects of dependent claims and/or are described in the following examples.

One advantage of the computer system is that further measures to save energy on the software side and/or hardware side can be triggered by coupling to existing energy-saving mechanisms, for example, a mechanism that deactivates a screen display. Preferably, the at least one software component is implemented for this purpose as a system service for the operating system, which system service is set up to monitor the operating system for an event to switch off a screen display and stop the at least second application when an event to switch off the screen display is detected and call the function that operates the computer system in the absence mode via the interface.

Advantageously, the operating system itself may also be switched to a restricted operating mode, for example, the so-called “Away Mode” of the Microsoft Windows operating system to reduce utilization of the computer system on the software side. A plurality of actions partially matched to one another can be carried out by activating a restricted operating mode provided by the operating system. In this case, the measures can be adapted by the software component if necessary.

Advantageously, the system component has at least one microcontroller with a plurality of programmable outputs. The system software component is set up to provide at least one control signal to change the at least one hardware component into the energy-saving state via at least one programmable output of the microcontroller when the function that operates the computer system in the absence mode is called. This makes it possible to trigger energy-saving measures which could not be achieved by mere software control.

For example, a first output of the microcontroller may be connected to a control connection of a processor of the computer, the power of the processor being restricted to a predetermined maximum power when at least one first control signal is provided at the control connection. The so-called PROCHOT signal of known Intel processors, which is usually used to avoid thermal overload situations, is suitable for this purpose, for example. Providing the PROCHOT signal makes it possible to reduce the power consumption of a processor, in terms of hardware, to a fraction of the conventional power consumption. In this case, applications executed on the processor continue to run, albeit with a highly restricted performance or speed.

These and other measures make it possible to restrict the energy consumption of the computer system to a fraction of the conventional power. For example, it is possible to reduce a conventional office PC to a power consumption of 3 to 20 W, with the result that its power consumption, despite substantial reachability of the computer system, moves to the order of magnitude of previously known sleep states in which meaningful use of the computer system is no longer possible.

Our systems are described in detail below using different examples with reference to the attached figures.

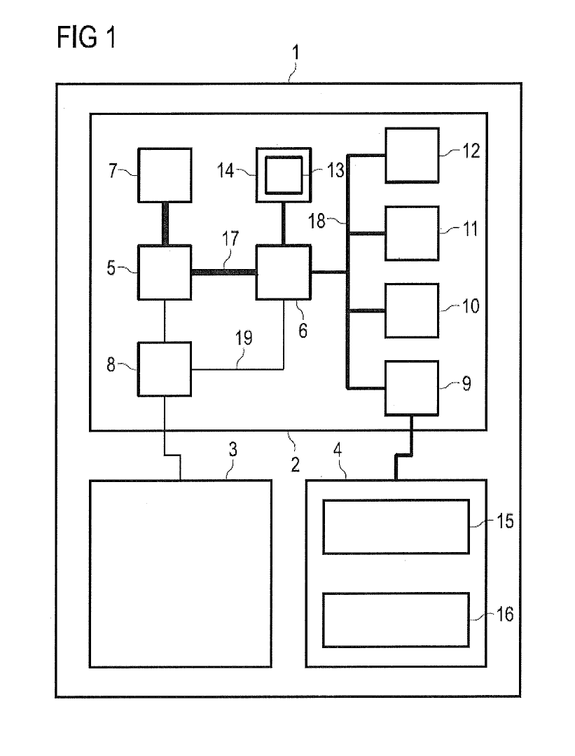

FIG. 1 schematically shows a system architecture of a computer system 1 according to one example. The computer system 1 comprises a system component in the form of a system board 2, a power supply unit 3 that converts a primary mains AC voltage into one or more secondary DC supply voltages, and a mass memory drive 4.

The computer system 1 may be, for example, a desktop computer system according to the common Intel x86 architecture. The power supply unit 3 is usually a switched mode power supply unit having one or more switching converters. The power supply unit 3 may comprise a plurality of switching converters, at least one switching converter being provided for the purpose of operating the computer system in an energy-efficient manner in a low-load range and at least one further switching converter which can be switched off being provided for the purpose of operating the computer system 1 in a full-load range. In addition, the power supply unit 3 may have a circuit for mains filtering and/or limiting a switch-on current when operating the power supply unit in the full-load range, which circuit can be switched off and/or bridged. The mass memory drive 4 may be, for example, a conventional magnetic memory drive having one or more rotating storage media or a semiconductor memory drive with non-volatile mass memory modules, in particular a so-called “Solid State Disk” (SSD).

The system board 2, generally referred to as the so-called “motherboard” or “mainboard,” may comprise a processor 5, a single-part or multi-part chipset 6, one or more volatile memory modules 7 and a microcontroller 8. The microcontroller 8 executes program code which is used, inter alia, for system management and for energy management of the computer system 1. The exact function of the microcontroller 8 is discussed in detail below. Further components, in particular a mass memory controller 9, a network interface 10 and an I/O interface 11, connect to the processor 5 and to the memory module 7 via the chipset 6. Furthermore, the processor 5 connects to a graphics module 12 either directly or via the chipset 6.

The components 5 to 12 of the system board 2 connect to one another via a plurality of bus systems. In particular, the processor 5, the chipset 6 and the memory modules 7 connect to one another via a system and/or memory bus 17. The chipset 6, the mass memory controller 9, the network interface 10, the I/O interface 11 and the graphics module 12 connect to one another via a peripheral bus 18, for example, a PCI-Express bus (PCIe). In addition, all or individual components of the system board 2 are connected to one another via a so-called “system management” bus 19. The microcontroller 8, the chipset 6 and the processor 5 connect to one another via the system management bus.

The system architecture of the computer system 1, as illustrated in FIG. 1, has only an exemplary character and naturally does not claim completeness. It is known a multiplicity of other system architectures for single-processor and multi-processor systems, to which the concepts, apparatuses and methods described below can be applied in an equivalent manner.

As a hardware addition to the otherwise conventional system architecture of the computer system 1, the microcontroller 8 connects to the PROCHOT signal input of the processor 5 via a control line. Alternatively or additionally, programmable control outputs of the microcontroller 8 connect, for example, to one or more control inputs of the power supply unit 3 and/or to voltage converters (not illustrated in FIG. 1) that adapt a general supply voltage to an operating voltage required by the processor 5.

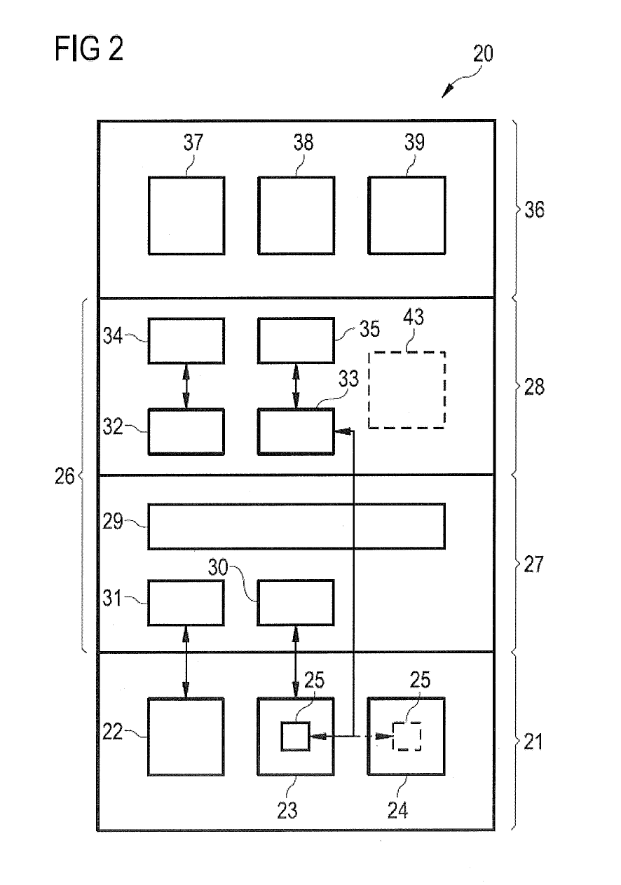

Further functions to manage the energy of the computer system 1 are provided or implemented using BIOS program code 13 which is stored in a non-volatile memory module 14 connected to the chipset 6. In particular, the BIOS program code 13 provides a so-called “energy management interface” according to the ACPI standard mentioned at the outset. The BIOS program code 13 additionally provides an extended interface, for example, for a system-specific energy-saving profile, one or more system-specific function calls or a BIOS function independent of the ACPI standard. The interfaces of the BIOS program code 13 may be addressed, for example, by an operating system 15 stored on the mass memory drive 4 or an operating-system-specific software component 16. The interaction between the individual software components 13, 15 and 16 is explained in detail below using the diagram according to FIG. 2.

FIG. 2 shows different software layers of a computer system 1, for example, the computer system 1 according to FIG. 1. Such diagrams are generally referred to using the term “Software Stack”.

A firmware layer 21 is at the lowest level of the software stack 20 in the illustration according to FIG. 2. The software of the firmware layer 21 may be, for example, conventional BIOS firmware or software that provides an interface according to the so-called “Extensible Firmware Interface” (EFI) standard. Standardized functions are provided via a BIOS interface 22, further standardized functions are provided via an ACPI interface 23 and system-specific functions are provided via one or more proprietary interfaces 24 using the firmware layer 21.

The ACPI interface 23 has been extended by at least one optional user-specified or system-specified function 25 compared to the ACPI standard. The function 25 allows a predetermined energy-saving profile to be called for an absence mode of the computer system 1 or allows individual functions of the microcontroller 8 to be addressed in a targeted manner, for example. Alternatively or additionally, the microcontroller 8 or energy-saving functions implemented by the latter can also be addressed via the proprietary interface 24.

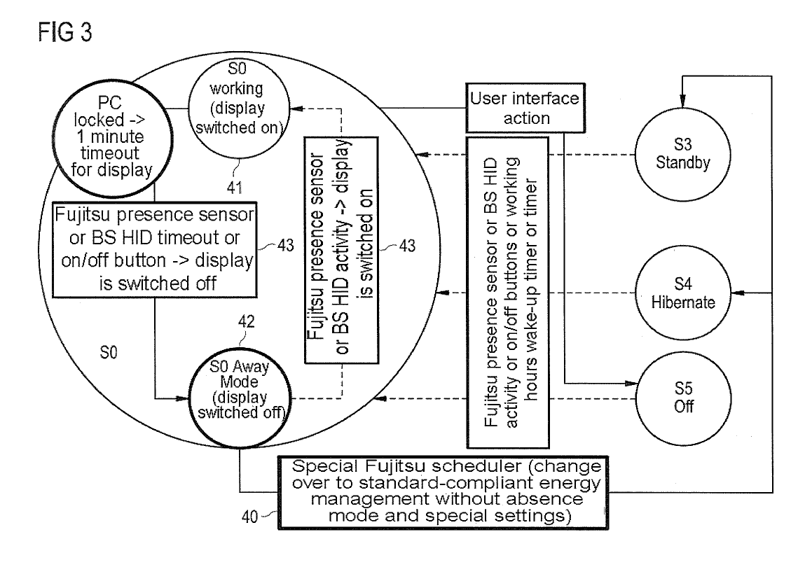

An operating system layer 26 is above the firmware layer 21. The operating system layer 26 is subdivided further into a kernel layer 27 and a user layer 28. The actual operating system core 29 and different system drivers are executed inside the kernel layer 27. Of the drivers, an ACPI driver 30 and a driver 31 for a real-time clock are illustrated in the illustrated example. Further software components (not illustrated in FIG. 2) can be executed in the kernel layer 27. Two system services 32 and 33 and two associated setting dialogs 34 and 35 are executed in the user layer 28. Furthermore, a scheduler 40 explained below with reference to FIG. 3 is executed there.

The first system service 32 is, for example, a software component present as standard and intended to deactivate a screen display during input pauses of a user. Such software components are also referred to as screensavers. For example, the first system service 32 can be configured, via the associated setting mask 34, to switch off a display using the graphics module 12 and therefore to deactivate a monitor connected thereto after input pauses of more than five minutes, that is to say periods of time in which the user does not make any keyboard or mouse inputs.

The second system service 33 may be used to initiate extended energy-saving measures while a user is absent. For this purpose, the second system service 33 monitors the first system service 32 and/or other software components of the operating system layer 26 for the occurrence of system events, for example, the switching-off or switching-on of a screen display. If it is detected that a screen display is switched off, the second system service 33 ensures that further measures to save energy which are preconfigured using the second setting dialog 35 are taken. In particular, the second system service 33 is used to call a predetermined energy-saving profile of the extended ACPI BIOS interface 23 via the ACPI driver 30. In this case, the BIOS layer 21 is used to activate a absence mode in which particular hardware components of the computer system 1 are deactivated or operated with reduced power.

An application layer 36 is above the operating system layer 26. Three applications 37, 38 and 39 may be executed inside the application layer 36. For example, the first application 37 is Voice-over-IP software to implement a telephone function by the computer system 1. The second application 38 is a web browser in the example. The third application 39 is a so-called “electronic appointments calendar”.

Different measures to save energy during operation of the computer system 1 when the absence of a user is detected are described below using the system architecture according to FIG. 1 and the software stack 20 according to FIG. 2. In this case, the term “absence” is understood as meaning both the actual absence of a user and the mere absence of user inputs to the computer system 1. The former can be detected, for example, using a motion sensor at the workstation. The latter is detected, for example, using timers inside the operating system layer 26 and, in particular, using the first system service 32. It is pointed out that the respective measures can be used both individually and in combination to reduce the energy requirement of the computer system 1 as far as possible.

A first measure to save energy involves the second system service 33 changing the operating system core 29 into a special operating mode. For example, a functionality referred to as an “Away Mode” to operate a computer system as a remote media server, which carries out a multiplicity of settings to optimize a computer system, is present in the kernel of the Microsoft Windows operating system as of the “Windows XP Media Center Edition 2005” version. If the measures implemented as standard are not suitable for the absence mode described here, they can be reconfigured or reversed by the second system service. For example, the Away Mode provides for the muting of local audio components not suitable for the absence mode of the computer system 1, as described below.

Another energy-saving measure involves suspending applications that are possibly not required. The suspension described can be carried out by the second system service 33 itself or indirectly by calling the restricted operating mode of the operating system 15. For this purpose, the second system service 33 has, for example, one or more filter lists with clearances or bans for predetermined applications. Such lists are also referred to as a “White List” and “Black List” in the field of electronic data processing.

For example, the second system service 33 has a white list containing applications absolutely intended to continue to run if absence of a user is detected to ensure functionality of the computer system 1. This includes, in particular, the first application 37 to provide the Voice-over-IP telephony. This is because, even if a user does not make any inputs using a keyboard of the computer system 1 over a relatively long time, the user is still supposed to remain reachable by telephone.

In contrast, in an alternative or additional black list, it is possible to enter applications that are supposed to be stopped, for example, ended or interrupted in terms of their execution, in any case when the computer 1 is activated. These include, in particular, particularly high-power applications, for example, the application 28 for web browsing with associated plug-ins to display animations. Such applications often run unnoticed by the user in the background and ensure a high degree of utilization of a processor 5. If a user does not make any inputs and the monitor connected to the computer system 1 is accordingly switched off, it is possible to dispense with the continued operation of such applications without substitution. Applications entered in the black list may be suspended by the second system service 33 when absence of the user is detected, with the result that no further computation time is allocated to them by the operating system 15.

Further applications, for example, the application 39, can either be entered by the user in the black list or in the white list or can be handled according to a predefined setting of the second setting mask 35. For example, such applications may continue to be operated with a greatly reduced computation time.

Energy-saving functions enabled by the lower software layers, in particular the firmware layer 21, and underlying hardware components may be called either individually using the function 25 of the ACPI interface 23 or of the proprietary interface 24 or may be activated as a collected set of associated settings by selecting a user-specific or system-specific ACPI profile. The second approach described harbors the advantage that such profiles can be integrated in a comparatively simple manner in standard operating system components, for example, the first system service 33 to set energy-saving measures.

The energy-saving measures provided on the hardware side may include, in particular, the activation of the PROCHOT signal by the microcontroller 8 to restrict the processor 5. As described with respect to FIG. 1, further measures may involve reconfiguring a power supply unit 3, for example, by deactivating a main converter and simultaneously activating an auxiliary converter and bridging a mains filter, and/or by reconfiguring configurable voltage converters of the system component 2. For example, it is possible to deactivate individual phases of a multiphase voltage converter in an absence mode of the computer system 1 to reduce the switching effort associated therewith.

Further measures to reduce an energy consumption of the computer system 1 triggered by software or hardware involve switching predetermined system components, for example, the network interface 10 or the I/O interface 11, into an operating mode with a reduced power consumption. In particular, WLAN controllers according to the IEEE 802.11 protocol family, Ethernet controllers according to the IEEE 802.2 protocol family and peripheral and host devices according to the USB standard may be switched into a particularly energy-saving mode by software by selecting predetermined profiles of an associated driver model. For example, the transmission power or data rate of a WLAN controller is reduced, parts of an Ethernet controller according to the IEEE 802.3az standard are changed to a standby state, and peripheral devices connected to a USB controller are put into an energy-saving state.

Another energy-saving measure involves predetermined events, for example, arrival of an email or telephone message, not automatically resulting in the activation of the display which is usually switched off when inactivity of a user is detected. Instead, the system service 33 or a further software component (not separately illustrated in FIG. 2) establishes an interface to a special signaling component of the computer system 1. For example, unread messages can be represented using fast flashing of an LED status display of a power supply display or acoustic signals from a system loudspeaker without activating a graphics module 12 and a screen connected to the latter. In contrast, other events, for example, an incoming video call, automatically result in the absence mode being left and in a screen display of the computer system 1 being activated.

The individual energy-saving measures described above can be combined in one or more predetermined energy-saving profiles. These energy-saving profiles may also be combined with already known energy-saving profiles, for example, the energy-saving states S3 (so-called “Save to RAM” sleep state), S4 (so-called “Save to Disk” or hibernate state) and S5 (software off) known from the ACPI standard. In this respect, another example provides a scheduler 40 which, in addition to manual changes between the different operating modes, also makes it possible to assume predetermined operating states depending on the time of day. A possible linking of operating states is indicated in FIG. 3.

The left-hand area of FIG. 3 illustrates the S0 state known from the ACPI standard. This state is subdivided into further operating states. In addition to the actual working mode 41 (“S0 working”) in which a display of the computer system is activated and a user is currently working with the computer system 1, provision is made of an absence mode 42 (“S0 Away Mode”) in which, although the processor 5 continues to be supplied with operating energy, the power consumed by the processor 5 and the tasks performed by the processor are greatly restricted, as described above.

The transition from the working mode 41 to the absence mode 42 may be triggered by detecting the absence of a user. For this purpose, system events of an operating system may be monitored, for example. For example, after a predetermined time in which input components are not used, the screensaver provided as standard in the operating system triggers a signal which results in the screen being switched off and possibly in the log-in screen being displayed. Alternatively, the transition or the absence of the user may also be effected using a hardware component, in particular a presence sensor 43 integrated in the display and intended to detect movements of the user. The transition in the opposite direction, that is to say the transition from the absence mode 42 to the working mode 41, may likewise be triggered by a suitable hardware component, for example, the presence sensor 43, or by a user manually pressing a button of the computer system 1.

After expiry of a predetermined time in the absence mode 42 or after reaching a predetermined time, the scheduler 40 can change the computer system 1 into a further energy-saving state, for example, the S3 standby state or the S4 hibernate state. For example, the system may remain in the absence mode 42 during normal working hours from 8 AM to 5 PM, but can be selectively switched to one of the three ACPI states mentioned after 5 PM.

It is also possible to deliberately change the computer system 1 into one of the three ACPI states mentioned by a deliberate user input, for example, an operating element of the computer system 1 or a graphical user interface of the operating system 15.

The system can also be automatically changed from one of the ACPI states S3, S4 or S5 back into the S0 state via the scheduler 40 or a hardware arrangement which is possibly present and intended to monitor a user. For example, the system can be automatically changed back into the absence mode 42 in the morning around 8 AM so that a user does not have to wait for the computer system 1 to boot at the beginning of work. Additionally or alternatively, the system can be automatically changed into the working mode 41 if a movement of a user in the area of the computer system 1 is detected. Such an action can also be manually triggered using an operating element of the computer system 1.

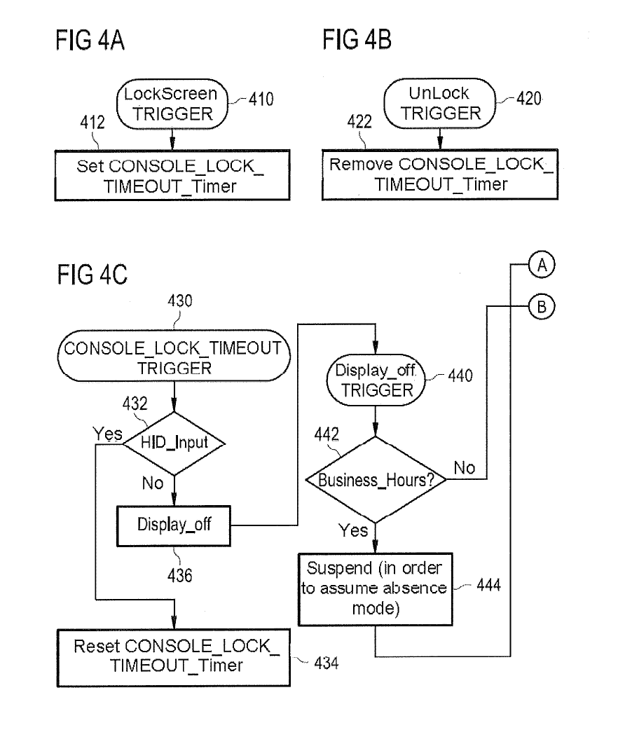

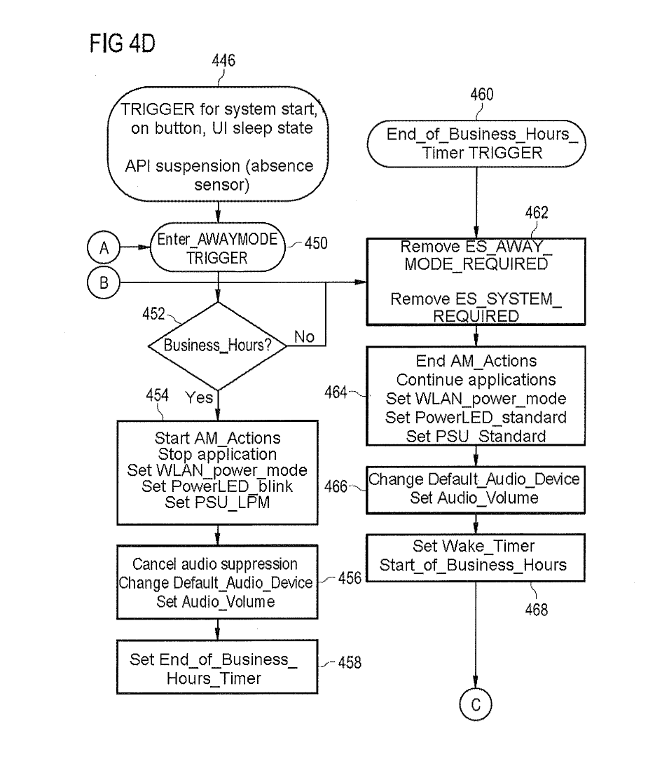

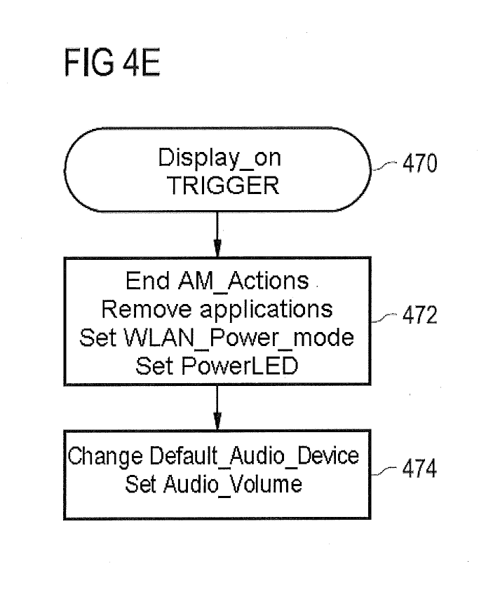

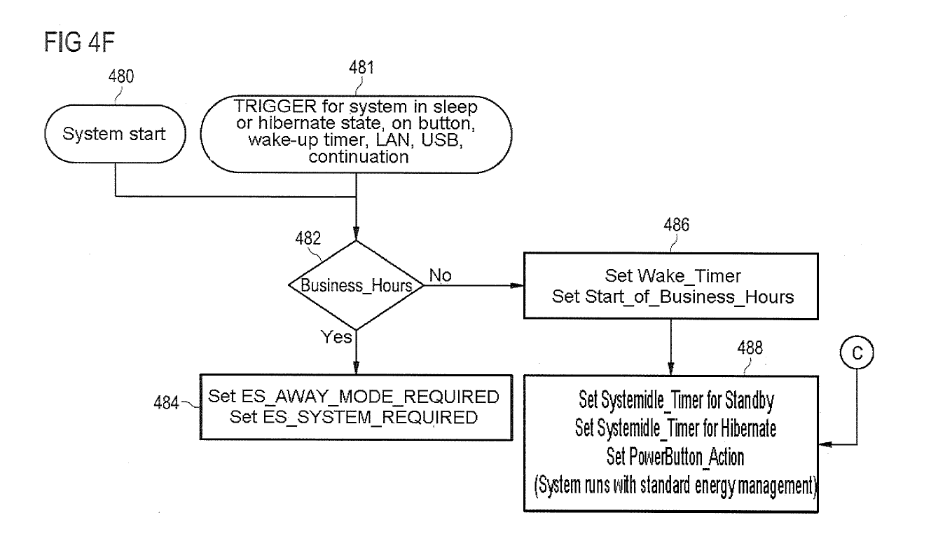

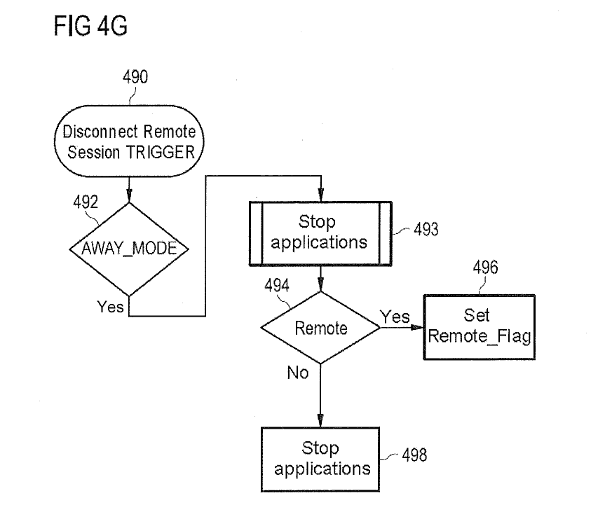

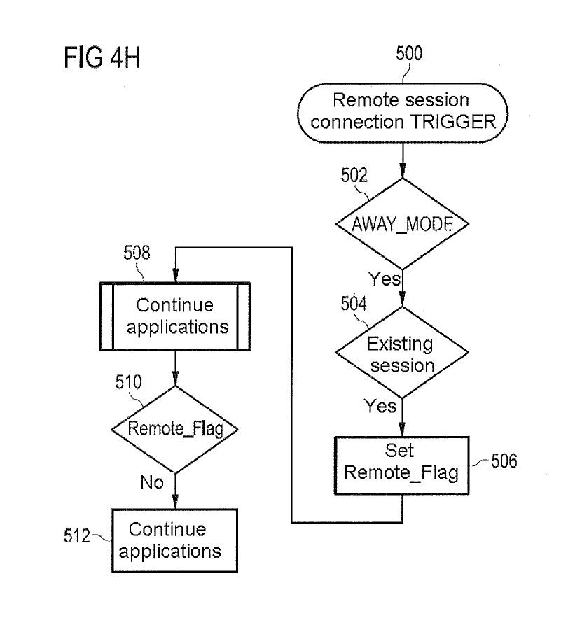

The flowcharts according to FIGS. 4A to 4H illustrate in detail the different triggering events and triggered actions according to an example of the absence mode 42 mentioned above.

It can be seen in FIGS. 4A and 4B that the concept is respectively tied to triggering events to lock and unlock a screen display that are predefined in a Windows system. In particular, FIG. 4A shows that, after a so-called “LockScreen” triggering event has been detected in step 410, a timer that triggers further actions is programmed in a subsequent step 412. The corresponding flowchart in FIG. 4B illustrates that, after unlocking of the screen has been detected in step 420, the above-mentioned timer is deleted in the subsequent step 422.

FIG. 4C illustrates what happens after the expiration of the programmed timer has been detected in step 430. A check is first carried out in a step 432 to determine whether further inputs are made by a Human Interface Device (HID), that is to say an input device, for example, a keyboard, a mouse or a touchpad. If this is the case, the programmed timer is reset in step 434 and the event processing is ended. Otherwise, if no further input by a user is detected, a screen display of the computer system 1 is first deactivated in step 436. This is used to trigger a further triggering event in step 440 with regard to the switching-off of the display unit. A check is then carried out in step 442 to determine whether a current time falls within conventional business hours. If this is the case, a suspend signal is generated in step 444 to activate the so-called “Away Mode” of the Microsoft Windows operating system. As a result, a corresponding triggering event is simultaneously generated in step 450, the processing of which event is explained below with reference to FIG. 4D.

As illustrated in FIG. 4D, the corresponding triggering event for step 450 can alternatively also be generated manually in step 446 by actuating an on-button of the computer system, calling the desired operating mode using a graphical user interface or a library call of a presence sensor 43. If the Away Mode has been triggered in step 450, a check is carried out in a step 452 to determine whether the current time of the computer system 1 falls within the normal operating times of the computer system 1.

If this is the case, a predetermined set of actions are carried out in the subsequent step 454 to increase the energy efficiency of the computer system 1 by choosing associated measures. In particular, user applications entered in a black list are stopped. In addition, a WLAN controller possibly contained in the computer system 1 is changed into an energy-saving mode. In addition, an operating display of the computer system 1, in particular an LED status display, that signals the assumed absence mode 42 is programmed using the proprietary interface 24. In the example, instead of permanent signaling to indicate a normal working mode 41, pulsating signaling to indicate the reduced power consumption in the absence mode 42 is used. Finally, different energy-saving hardware mechanisms are activated. For example, a power supply unit 3 can be changed into an operating mode with a greatly reduced output power.

In a subsequent step 456, audio outputs of predetermined applications are reconfigured for the absence mode. In particular, local audio signaling which was previously deactivated by the Away Mode is reactivated (unmute), an audio output device predetermined for the absence mode 42 is stipulated as the standard audio output device and a predetermined volume is selected. For example, it is useful to divert an audio output from an installed loudspeaker of a possibly deactivated monitor to an internal loudspeaker of the computer system 1. This ensures that incoming messages, for example, emails or telephone calls can be reliably signaled to the user even if the display is switched off.

In a final step 458, a timer of a real-time clock is finally programmed for the end of the calculated business hours.

In a step 460, a triggering event is generated using this timer at the end of the conventional business hours. After this event has been detected in step 460 or in the event of a negative result of the queries in steps 442 and 452, a system variable to indicate that the activation of the previously described Away Mode of the operating system 15 is no longer required is deleted in step 462. If system variables are set, it is indicated to the energy management of the computer that the Away Mode is intended to be assumed instead of a conventional ACPI S3 standby operating mode in which an operating state of the computer is held in the volatile memory. However, this is not required outside business hours.

Different measures implemented in step 454 are then reversed in a step 464. In particular, a power supply unit 3 is changed into a normal operating state again, an LED status display of the computer system 1 is programmed for normal, in particular permanent, signaling and a WLAN controller is changed into a normal operating state. Finally, the user applications stopped in step 454 are continued. In a subsequent step 466, the normal audio settings are restored and the measures in step 456 are therefore reversed.

In a step 468, a timer of the real-time clock is programmed for the start of the subsequent business hours. The computer system 1 then changes into the power management according to the operating system specifications, which is explained below with reference to FIG. 4F.

FIG. 4E illustrates which actions are carried out during the absence mode 42 when a triggering event to activate the screen is detected in step 470. After the triggering event has been detected, the applications suspended in the meantime are removed from a corresponding black list in step 472. In addition, a WLAN controller is reset to a normal operating mode. Finally, an LED status display of the computer system 1 is configured for normal operation again. In a step 474, the audio settings configured during normal operation for the computer system 1 are restored.

FIG. 4F illustrates the relationships between the different operating modes of the computer system 1. A switch-on event for the computer system 1 is detected via the event 480 or 481. The event in step 480 indicates the system start of the computer system 1, for example, by providing a supply voltage. The event in step 481 indicates triggering of an operating element in a sleep state (ACPI S3) or a hibernate state (ACPI S4) of the computer system 1, reaching of a preprogrammed wake-up time or reception of a wake-up command via a network or USB interface. After receiving the switch-on event in step 480 or 481, a check is carried out in step 482 to determine whether the current time falls in the conventional operating hours. If this is the case, system variables are used in step 484 to signal that the previously described Away Mode is intended to be used in addition to the normal energy-saving states. As described above, the system variables which have been set cause the Away Mode to be used as the energy-saving mode instead of the ACPI S3 standby mode. Otherwise, a wake-up timer to reach the normal business hours is programmed in step 486. The timers predefined as standard by the energy-saving management of the operating system 15 are then programmed in step 488 according to the preset values to assume the ACPI states S3, S4 and/or S5. In addition, according to the ACPI specification, a predetermined action to actuate an operating element of the computer system 1 is programmed. As a result, the computer system 1 then continues to run with the known energy-saving mechanisms. In particular, after the predetermined period of time, the system changes into one of the ACPI sleep states S3, S4 or S5.

FIGS. 4G and 4H show handling of user applications during the absence mode 42. In step 490, a triggering event that disconnects a network session is generated. A check is then carried out in step 492 to determine whether the computer system is in the Away Mode. If this is the case, applications that are still running are possibly stopped in process 493. In this case, a check is carried out in step 494 to determine whether the running applications are network applications. If this is the case, a system identification for the corresponding application is set in step 496 to ensure the continued operation of the application in the Away Mode. Otherwise, the application is suspended from continued operation in step 498.

FIG. 4H shows, in step 500, detection of an event to connect a network session. A check is then carried out in step 502 to determine whether the operating system 15 is in the Away Mode. If this is the case, a check is carried out to determine whether there is already an existing session involving the requested application. If one of the two queries 504 and 502 has a negative response, no further measures are carried out. However, if both queries have a positive response, a corresponding system variable to identify the application is set in a subsequent step 506. The applications required in the absence mode are then continued in a process 508. For this purpose, a check is carried out in a step 510 to determine whether the corresponding system variable has been set for a respective application. If this is not the case, the relevant application is continued in step 512.

Although only an absence mode 42 was respectively described in the preceding description using all available measures, it is possible to use individual measures or subgroups of measures to implement further energy-saving modes. For example, it is possible to dispense with the suspension of user applications to control a conventional idle state of the computer system. This is advantageous, in particular, when it is detected that the currently running applications produce such a low system load that operation of the computer system 1 can be ensured even with a reduced hardware energy consumption, for example, by restricting the processor 5 and/or reconfiguring the power supply unit 3 or voltage controllers. Such energy-saving states can be linked to one another via timers or the scheduler 40, with the result that only a first part of energy-saving measures is initially carried out during brief working pauses of a user, for example, and further energy-saving measures are gradually added during longer working pauses of the user.

Desktop computer systems, in particular, can be operated in an operating state controlled for the respective operation by combining the described measures in conjunction with the particularly flexible concept of combined hardware and software control. A user therefore need no longer actively intervene in the energy management and can simply leave his computer system switched on without this resulting in an increased energy consumption.

The described computer system has a number of advantages, in particular:
reduction of the energy consumption of the computer system to a few watts, for example, 4.5 W for a conventional desktop PC with standard components, in working pauses,
maintenance of network connections which simultaneously prevents undesired changes to files opened by a user by other users,
ability to reach the computer system during normal working hours, for example, for maintenance purposes, from a remote computer system,
possibility of informing the user of incoming messages and calls even in the absence mode,
possibility of informing the user of unread messages using an extended state display when the monitor is switched on,
possibility of integration with known energy-saving measures of the hardware and software components used, and
dispensing with special hardware and software components, as are used, in particular, in mobile systems to reduce energy consumption.

1.-15. (canceled)

16. A computer system comprising:
a system component having a non-volatile memory module that stores a system software component of a firmware layer to control hardware components of the system component;
at least one non-volatile mass memory that stores an operating system and associated software components; and
at least one power supply unit that supplies the system component and the non-volatile mass memory with a supply voltage;
the system software component of the firmware layer providing at least one interface that selects energy-saving functions, which interface provides at least one function to operate the computer system in an absence mode in which at least one first application running on the computer system can be addressed via a network connection;
at least one software component of an operating system layer being executed by the operating system during operation of the computer system, which software component is configured to stop at least one second application when absence of a user is detected and call the function that operates the computer system in the absence mode via the interface; and
the system software component of the firmware layer configured to change at least one hardware component of the computer system into an energy-saving state when the function that operates the computer system in the absence mode is called to reduce energy consumption of the computer system when the user is absent.

17. The computer system according to claim 16, wherein the at least one software component of the operating system layer implements a system service for the operating system, the system service configured to monitor the operating system for an event to switch off a screen display and stop the at least one second application when the event to switch off the screen display is detected and to call the function that operates the computer system in the absence mode via the interface.

18. The computer system according to claim 17, wherein the system service is further configured to switch the operating system to a restricted operating mode and/or to activate at least one energy-saving measure of at least one device driver when the event to switch off the screen display is detected.

19. The computer system according to claim 18, wherein at least one energy-saving measure comprises at least one measure selected from the group consisting of activating an energy-saving WLAN profile, reducing a bandwidth of a network adapter and activating a sleep state, an idle state or a standby state of an external peripheral device, in particular by activating a USB energy-saving mode.

20. The computer system according to claim 16, wherein the system component comprises at least one microcontroller with at least one programmable output, the system software component configured to provide at least one control signal to change the at least one hardware component into the energy-saving state via the at least one programmable output of the microcontroller when the function that operates the computer system in the absence mode is called.

21. The computer system according to claim 20, wherein at least one output of the microcontroller connects to a control connection of a processor of the computer system, and the power of the processor is restricted to a predetermined maximum power when a control signal is provided at the control connection.

22. The computer system according to claim 20, wherein at least one output of the microcontroller connects to a voltage control circuit that converts a supply voltage provided by the power supply unit to a required input voltage of a processor, and the circuit is switched to a configuration for operation with a low load when a control signal is provided.

23. The computer system according to claim 20, wherein at least one output of the microcontroller connects to the power supply unit, and the power supply unit is switched to a configuration for operation with a load that is reduced in comparison with normal operation when a control signal is provided.

24. The computer system according to claim 16, further comprising a sensor that detects the presence of a user in a working area assigned to the computer system, wherein at least one of the operating system and the software component is configured to call the function that operates the computer system in the absence mode via the interface when absence of a user is detected on the basis of an output signal from the sensor.

25. The computer system according to claim 16, further comprising at least one of an optical signaling apparatus and an acoustic signaling apparatus, the signaling apparatus being coupled to the system component, the software component further configured to indicate predetermined events of the first application via the signaling apparatus in the absence mode.

26. The computer system according to claim 25, wherein the at least one first application is a communication application, an email application, a chat application, a telephone application or a video telephone application, and the predetermined event is the arrival of a message, receipt of an email or a chat message or signaling of an incoming call or video call.

27. The computer system according to claim 16, wherein the at least one software component of the operating system layer is configured to retrieve a list containing applications that are not allowed in the absence mode and to temporarily stop at least applications contained in the list in the absence mode.

28. The computer system according to claim 16, wherein the at least one software component of the operating system layer is configured to determine a class of running applications and temporarily stop at least applications of a predetermined class, in particular web browsers, in the absence mode.

29. The computer system according to claim 16, further comprising at least one scheduler, the scheduler configured to change the computer system either to the absence mode or to a predetermined energy-saving mode on the basis of a predefined schedule when the absence of the user is detected.

30. The computer system according to claim 29, further comprising at least one real-time clock, the software component of the operating system layer and/or the scheduler configured to program the real-time clock before adopting the energy-saving mode such that the computer system is restored to the absence mode or an operating mode at a subsequent time according to the predefined schedule.

31. A non-volatile memory device storing at'least one software component of an operating system layer of a computer system, which cause a data processing device of the computer system to perform the following steps on execution of the at least one software component:
detecting the absence of a user from the computer system;
when the absence of a user is detected, stopping at least one application executing under the control of the operating system in an application layer; and
when the absence of a user is detected, further calling a function provided by an interface of a system software component of a firmware layer of the computer system that operates the computer system in an absence mode, wherein the system software component is configured to change at least one hardware component of the computer system into an energy-saving state when the function that operates the computer system in the absence mode is called to reduce the energy consumption of the computer system.

32. The non-volatile memory device according to claim 31, further configured switch the operating system to a restricted operating mode when the absence of a user is detected.

33. A non-volatile memory device storing at least one system software component of a firmware layer of a computer system that controls hardware components of a system component of the computer system, which cause a data processing device of the computer system to perform the following steps on execution of the at least one system software component:
providing at least one interface that selects energy-saving functions, the interface providing at least one function that operates the computer system in an absence mode, in which at least one first application running under the control of an operating system in an application layer of the computer system can be addressed via a network connection;
when the function that operates the computer system in the absence mode is called by software component of an operating system layer of the computer system, changing at least one hardware component of the computer system into an energy-saving state to reduce the energy consumption of the computer system.
